(19) United States
(12) Patent Application Publication
(10) Pub. No.: US 2025/0094524 A1
(43) Pub. Date: Mar. 20, 2025

(54) ELECTRONIC DEVICE AND METHOD FOR FACTORIZATION OF TARGET NUMBER

(71) Applicant: KOREA UNIVERSITY RESEARCH AND BUSINESS FOUNDATION, Seoul (KR)

(72) Inventors: Chulwoo KIM, Seoul (KR); Hyundo JUNG, Seoul (KR); Hyunjin KIM, Seoul (KR); Jinwoo JEON, Seoul (KR); Woojin LEE, Seoul (KR); Yohan CHOI, Seoul (KR)

(73) Assignee: KOREA UNIVERSITY RESEARCH AND BUSINESS FOUNDATION, Seoul (KR)

(21) Appl. No.: 18/495,169

(22) Filed: Oct. 26, 2023

(30) Foreign Application Priority Data
Sep. 18, 2023 (KR) 10-2023-0124278

(51) Int. Cl. G06F 17/11; G06F 5/01

(52) U.S. Cl. CPC G06F 17/11; G06F 5/01

(57) ABSTRACT

Provided is an electronic device for factorization of a target number. The electronic device includes an energy calculating circuit configured to generate input values for updating bits of a candidate number based on an energy function that has a minimum when the candidate number is a factor of the target number, and bit updating circuits corresponding to the bits of the candidate number, respectively.

### CROSS-REFERENCE TO RELATED APPLICATION

This application is based on and claims priority under 35 U.S.C. § 119 to Korean Patent Application No. 10-2023-0124278, filed on Sep. 18, 2023, in the Korean Intellectual Property Office, the disclosure of which is incorporated by reference herein in its entirety.

### BACKGROUND

### 1. Field

The disclosure relates to factorization using an electronic device. In more detail, the disclosure relates to factorization based on an energy function.

This disclosure was supported by Samsung Research Funding & Incubation Center of Samsung Electronics under Project Number SRFC-IT2101-03.

### 2. Description of the Related Art

Factorization of large numbers is difficult with current hardware technology. There was an attempt to factorize a 232-digit number, but it took two years to find a solution.

Difficulty of finding a solution may mean that it is difficult to break through a barrier. Such a difficulty of breaking through a barrier is suitable for use in security. Thus, prime factorization is often used in cryptography.

Difficulty of finding a solution often stimulates the interest of people. Factorization of large numbers arouses more interest in that it may be a key to a cryptography, and various methods have been attempted to solve factorization of large numbers. However, these methods require too much hardware resources or take too much time.

With the advent of quantum computers, it has been theoretically proven that prime factorization could be solved in a polynomial time. However, quantum computer hardware technology to actually implement the theory is still insufficient.

### SUMMARY

An object of the technical spirit of the disclosure is to provide an electronic device and method for factorization of a target number.

Additional aspects will be set forth in part in the description which follows and, in part, will be apparent from the description, or may be learned by practice of the presented embodiments of the disclosure.

An electronic device for factorization of a target number according to the technical spirit of the disclosure for achieving the above technical object is disclosed.

According to an embodiment, the electronic device includes an energy calculating circuit configured to generate input values for updating bits of a candidate number based on an energy function that has a minimum when the candidate number is a factor of the target number, and bit updating circuits corresponding to the bits of the candidate number, respectively, wherein the energy calculating circuit is configured to receive bit values of the candidate number from the bit updating circuits and generate the input values based on the bit values of the candidate number, and a k^{th} bit updating circuit of the bit updating circuits is configured to receive a k^{th} input value for a k^{th} bit of the candidate number from the energy calculating circuit among the input values and update the k^{th} bit of the candidate number based on the k^{th} input value.

The candidate number may include a first candidate number and a second candidate number, and the bit updating circuits may be configured to update the first candidate number in a cycle for updating the first candidate number, and update the second candidate number in a cycle for updating the second candidate number.

The bit updating circuits may configured to simultaneously update each bit of the candidate number.

The electronic device may further include a decision circuit configured to determine whether factorization of the target number is complete based on the candidate number.

The decision circuit may be configured to determine whether factorization of the target number is complete by performing a modulo operation on the target number and the candidate number.

The electronic device may further include a sieving circuit configured to determine a final candidate number among the candidate number and odd numbers adjacent to the candidate number.

The sieving circuit may be configured to determine, as the final candidate number, a number that is not a multiple of 3, a multiple of 5, and a multiple of 7 among the candidate number and the odd numbers adjacent to the candidate number.

The decision circuit may be configured to determine whether factorization of the target number is complete by performing a modulo operation on the target number and the final candidate number.

The energy calculating circuit may include an energy difference calculating circuit configured to calculate a difference between a value of the energy function when the k^{th} bit of the candidate number is 0 and a value of the energy function when the k^{th} bit of the candidate number is 1.

The energy calculating circuit may further include an energy shifting circuit configured to generate the k^{th} input value by performing a shift operation on output of the energy difference calculating circuit.

The energy shifting circuit may be configured to perform the shift operation by cycling through predetermined shift values and using the shift values as a shift value.

The energy shifting circuit may be configured to perform the shift operation by cycling through predetermined shift values in order from small to large and using the shift values as a shift value.

The k^{th} bit updating circuit of the bit updating circuits may be configured to update the k^{th} bit of the candidate number to 0 or 1 based on a probability value corresponding to the k^{th} input value.

The candidate number may include a first candidate number and a second candidate number, in a current cycle for updating the first candidate number and the second candidate number, the energy calculating circuit may be configured to perform a first sub cycle of generating a first input value based on the first candidate number and the second candidate number, the bit updating circuit may be configured to perform a second sub cycle of updating the first candidate number based on the first input value, the energy calculating circuit may be configured to perform a third sub cycle of generating a second input value based on the first candidate number, which is updated in the second sub cycle, and the second candidate number, and the bit updating circuit may be configured to perform a fourth sub cycle of updating the second candidate number based on the second input value.

The energy calculating circuit may further include a decision circuit configured to determine whether factorization of the target number is complete based on the first candidate number and the second candidate number, wherein the decision circuit may be configured to determine whether factorization of the target number is complete based on the first candidate number, which is updated in a second sub cycle of the current cycle, between the second sub cycle of the current cycle and a second sub cycle of a next cycle, and determine whether factorization of the target number is complete based on the second candidate number, which is updated in the fourth sub cycle of the current cycle, between the fourth sub cycle of the current cycle and a fourth sub cycle of the next cycle.

A method for factorization of a target number according to the technical spirit of the disclosure for achieving the above technical object is disclosed.

According to an embodiment, the method includes a plurality of candidate update cycles for updating a first candidate number and a second candidate number, wherein a current candidate update cycle of the plurality of candidate update cycles may include a first energy calculating cycle of generating first input values corresponding to bits of the first candidate number based on an energy function that has a minimum when the first candidate number and the second candidate number are factors of the target number, a first bit updating cycle of updating a bit of the first candidate number based on a corresponding first input value, for each of the bits of the first candidate number, a second energy calculating cycle of generating second input values corresponding to bits of the second candidate number based on the energy function, and a second bit updating cycle of updating a bit of the second candidate number based on a corresponding second input value, for each of the bits of the second candidate number.

The first energy calculating cycle may include calculating a difference between a value of the energy function when a k^{th} bit of the first candidate number is 0 and a value of the energy function when the k^{th} bit of the first candidate number is 1, and generating a k^{th} first input value corresponding to the k^{th} bit of the first candidate number by performing a shift operation on the calculated difference for the first candidate number.

The second energy calculating cycle may include calculating a difference between a value of the energy function when a k^{th} bit of the second candidate number is 0 and a value of the energy function when the k^{th} bit of the second candidate number is 1, and generating a k^{th} second input value corresponding to the k^{th} bit of the second candidate number by performing a shift operation on the calculated difference for the second candidate number.

The generating of the k^{th} first input value may include performing the shift operation by alternately cycling through predetermined shift values and using the shift values every candidate update cycle among the plurality of candidate update cycles, wherein the generating of the k^{th} second input value may include performing the shift operation using the shift values that are equal to in the generating of the k^{th} first input value.

The first bit updating cycle may include updating the bit of the first candidate number to 0 or 1 based on a probability value corresponding to the corresponding first input value for each of the bits of the first candidate number.

The second bit updating cycle may include updating the bit of the second candidate number to 0 or 1 based on a probability value corresponding to the corresponding second input value for each of the bits of the second candidate number.

The current candidate update cycle may include a first sieving cycle of determining a first final candidate number among the first candidate number updated in the first bit updating cycle and odd numbers adjacent to the updated first candidate number, between the first bit updating cycle and the second energy calculating cycle, and a second sieving cycle of determining a second final candidate number among the second candidate number updated in the second bit updating cycle and odd numbers adjacent to the updated second candidate number, after the second bit updating cycle.

The method may further include a first decision cycle of determining whether factorization of the target number is complete based on the first final candidate number, between the first sieving cycle of the current candidate update cycle and a first sieving cycle of a next candidate update cycle, and a second decision cycle of determining whether factorization of the target number is complete based on the second final candidate number, between the second sieving cycle of the current candidate update cycle and a second sieving cycle of the next candidate update cycle.

A computer-readable recording medium having recorded thereon a program for executing a method for factorization of a target number according to the technical spirit of the disclosure for achieving the above technical object is disclosed.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment;

FIG. 2 is a diagram for explaining operations of an energy calculating circuit and bit updating circuits, according to an embodiment;

FIG. 3 is a block diagram of an energy calculating circuit, according to an embodiment;

FIG. 4 is a block diagram of a k^{th} bit updating circuit, according to an embodiment;

FIG. 5 is a timing diagram showing operations of an energy calculating circuit and bit updating circuits, according to an embodiment;

FIGS. 6 and 7 show an electronic device according to embodiments;

FIG. 8A is a timing diagram showing operations of an energy calculating circuit, bit updating circuits, a sieving circuit, and a decision circuit, according to an embodiment;

FIG. 8B is a timing diagram showing operations of an energy calculating circuit, bit updating circuits, and a decision circuit, according to an embodiment;

FIGS. 9A to 9C are diagrams for explaining a probabilistic annealing method, according to an embodiment;

FIGS. 10A to 10C are graphs for explaining a difference between a probabilistic annealing method and methods according to the related art;

FIG. 11 is a flowchart of a method for factorization of a target number according to an embodiment;

FIGS. 12A to 13 are diagrams for explaining an effect of a method according to embodiments;

FIG. 14 is a block diagram of an electronic system according to an embodiment; and

FIGS. 15A and 15B are graphs for explaining an effect of an electronic system according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

In the disclosure, embodiments regarding factorization may also be equally applied to prime factorization.

In the disclosure, a target number is an object of factorization. The target number may be any natural number. The target number may be a semiprime.

In the disclosure, a candidate number is a candidate for a solution of factorization of the target number. When the target number is a semiprime, the candidate number may be a candidate for a solution of prime factorization of the target number.

Hereinafter, various embodiments are described with reference to the accompanying drawings.

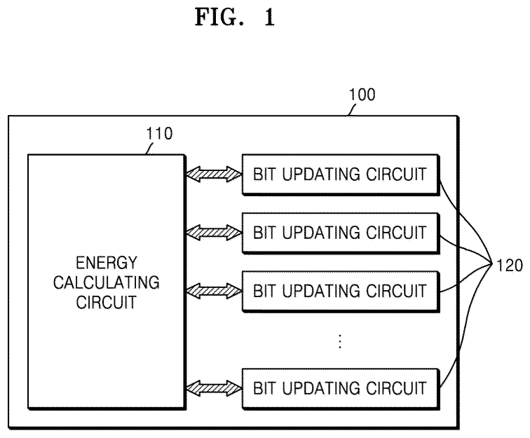

FIG. 1 is a block diagram of an electronic device 100 according to an embodiment.

According to an embodiment, the electronic device 100 may be configured to perform factorization of a target number. In more detail, the electronic device 100 may be configured to factorize the target number by updating a candidate number such that an energy function has a minimum.

The energy function may be a function that has a minimum when the candidate number is a factor of the target number. Accordingly, a candidate number obtained when the electronic device 100 optimizes the energy function may be a solution to factorization of the target number.

The energy function may be based on the Boltzmann machine. Global energy E of a system in the Boltzmann machine may be defined according to Equation 1.

$$E = - ( \sum {w}_{ij} {x}_{i} {x}_{j} + \sum {b}_{i} {x}_{i} ) \qquad Equation 1$$

In Equation 1, xᵢ is a state of an i^{th} spin, wᵢⱼ is a weight between an i^{th} spin and a j^{th} spin, and bi is a bias term of an i^{th} spin.

From the global energy defined by Equation 1, a probability P(X) of a state vector X may be defined according to Equation 2.

$$P ( X ) = \frac{exp [ - E ( X ) ]}{{\sum }_{X} exp [ - E ( X ) ]} \qquad Equation 2$$

In the Boltzmann machine, when the global energy is a minimum, P(X) has a maximum and the state vector X is a solution. In other words, when the state vector X satisfies the solution, P(X) has a maximum and the global energy of the Boltzmann machine has a minimum.

According to an embodiment, an energy function E(S) based on the Boltzmann machine may be defined according to Equation 3.

$$E ( S ) = {{E}_{0} ( AB - N )}^{2} \qquad Equation 3$$

In Equation 3, N is a target number, A is a first candidate number, B is a second candidate number, and E₀ is a coefficient. The energy function E(S) has a minimum when the first and second candidate numbers A and B are factors of N. Thus, the electronic device 100 may be configured to factorize a target number N by updating the first and second candidate numbers A and B such that the energy function E(S) has a minimum.

In an embodiment, the electronic device 100 includes an energy calculating circuit 110 and a plurality of bit updating circuits 120.

The energy calculating circuit 110 generates input values to update bits of a candidate number. For example, for a candidate number having m bits, the energy calculating circuit 110 may generate m input values for updating the m bits.

The energy calculating circuit 110 may generate first input values in a cycle for updating a first candidate number A, and generate second input values in a cycle for updating a second candidate number B. For example, for the first candidate number A having m bits, the energy calculating circuit 110 may generate m first input values in a cycle for updating the first candidate number A. For the second candidate number B having m bits, the energy calculating circuit 110 may generate m second input values in a cycle for updating the second candidate number B.

The plurality of bit updating circuits 120 may update bits of the candidate number based on the input values generated by the energy calculating circuit 110.

For any k that satisfies 1≤k≤m, a k^{th} bit updating circuit may update a k^{th} bit of the candidate number based on a k^{th} input value of the energy calculating circuit 110.

In some embodiments, the k^{th} input value may be a difference between a value of the energy function E(S) when a k^{th} bit value of the candidate number is 0 and a value of the energy function E(S) when the k^{th} bit value of the candidate number is 1. Thus, the k^{th} input value may be represented according to Equation 4.

$${I}_{k} = E ( {s}_{k} = 0 ) - E ( {s}_{k} = 1 ) \qquad Equation 4$$

In Equation 4, E(sₖ=0) is a value of the energy function E(S) when the k^{th} bit value is 0, and E(sₖ=1) is a value of the energy function E(S) when the k^{th} bit value is 1.

When E₀ is 2³⁻²ⁿ and n is the number of bits of the target number N, from Equations 3 and 4, a k^{th} input value for the first candidate number A may be represented according to Equation 5.

$${I}_{k} = {2}^{3 + k - 2 n} ( N - AB ) B \pm {2}^{1 + 2 k - 2 n} {B}^{2} \qquad Equation 5$$

From Equations 3 and 4, a k^{th} input value for the second candidate number B may be represented according to Equation 6.

$${I}_{k} = {2}^{3 + k - 2 n} ( N - AB ) A \pm {2}^{1 + 2 k - 2 n} {A}^{2} \qquad Equation 6$$

In some embodiments, a k^{th} input value may be a value obtained by performing a shift operation on a difference between a value of the energy function E(S) when a k^{th} bit value of a candidate number is 0 and a value of the energy function E(S) when the k^{th} bit value of the candidate number is 1. In the same expression, the k^{th} input value may be a value obtained by multiplying the difference between the value of the energy function E(S) when the k^{th} bit value is 0 and the value of the energy function E(S) when the k^{th} bit value is 1 by a coefficient. Thus, the k^{th} input value may be represented according to Equations 7 and 8.

$${I}_{k} = ( E ( {s}_{k} = 0 ) - E ( {s}_{k} = 1 ) ) ≪ β \qquad Equation 7$$

$${I}_{k} = α ( E ( {s}_{k} = 0 ) - E ( {s}_{k} = 1 ) ) \qquad Equation 8$$

In Equation 7, β is a shift value, and in Equation 8, a coefficient α is 2^{β}.

When E₀ is 2³⁻²ⁿ, from Equations 3, 7, and 8, the k^{th} input value for the first candidate number A may be represented according to Equation 9.

$${I}_{k} = {2}^{β} ( {2}^{3 + k - 2 n} ( N - AB ) B \pm {2}^{1 + 2 k - 2 n} {B}^{2} ) \qquad Equation 9$$

From Equations 3, 7, and 8, the k^{th} input value for the second candidate number B may be represented according to Equation 10.

$${I}_{k} = {2}^{β} ( {2}^{3 + k - 2 n} ( N - AB ) A \pm {2}^{1 + 2 k - 2 n} {A}^{2} ) \qquad Equation 10$$

Equations 9 and 10 are derived based on the energy function E(S), but direct calculation of the energy function E(S) is not required. Equations 9 and 10 are functions for the target number and the first and second candidate numbers A and B, and are not functions for a weight. Thus, to calculate an input value Iₖ of Equations 9 and 10, no weight-spin MAC operation is required.

The energy calculating circuit 110 may be configured to generate input values based on Equations 9 and 10. Thus, the energy calculating circuit 110 may not require a circuit for weights.

The energy calculating circuit 110 may generate input values from Equations 9 and 10 based on the energy function E(S), and the bit updating circuits 120 may update the first and second candidate numbers A and B to optimize the energy function E(S) based on the input values. Thus, the electronic device 100 may perform factorization of a target number based on a fully-connected Boltzmann machine.

In some embodiments, the electronic device 100 may include m plural bit updating circuits. The m plural bit updating circuits may update bits of the first candidate number A in a cycle for updating the first candidate number A and update bits of the second candidate number B in a cycle for updating the second candidate number B.

In some embodiments, the electronic device 100 may include 2 m plural bit updating circuits. The m plural bit updating circuits may update the bits of the first candidate number A, and other m plural bit updating circuits may update the bits of the second candidate number B.

In some embodiments, the energy calculating circuit 110 and/or the plurality of bit updating circuits 120 may include electronic circuits. For example, the energy calculating circuit 110 and/or the plurality of bit updating circuits 120 may include electronic circuits based on a complementary metal-oxide-semiconductor (CMOS), electronic circuits based on a flip-flop, or electronic circuits based on a latch, but are not limited thereto. For example, the energy calculating circuit 110 and/or the plurality of bit updating circuits 120 may include a field-programmable gate array (FPGA), but are not limited thereto.

In some embodiments, the energy calculating circuit 110 and/or the plurality of bit updating circuits 120 may include a processor. For example, the energy calculating circuit 110 and/or the plurality of bit updating circuits 120 may include a central processing unit (CPU) or a graphics processing unit (GPU), but are not limited thereto.

In some embodiments, the electronic device 100 may further include a processor and a memory for operations of the energy calculating circuit 110 and the plurality of bit updating circuits 120.

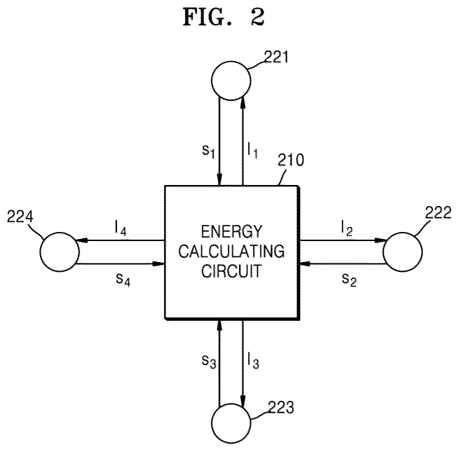

FIG. 2 is a diagram for explaining operations of an energy calculating circuit 210 and bit updating circuits 221 to 224, according to an embodiment.

With reference to FIG. 2, an operation of the energy calculating circuit 210 for the four bit updating circuits 221 to 224 will be described. In an embodiment, the four bit updating circuits 221 to 224 are used for convenience of explanation. The number of the bit updating circuits 221 to 224 is not limited thereto.

The energy calculating circuit 210 generates four input values I₁ to I₄ for updating four bits s₁ to s₄ of the candidate number.

For example, a first input value I₁ may be 2^{β}(E(s₁=0)−E(s₁=1)), a second input value I₂ may be 2^{β}(E(s₂₌₀)−E(s₂₌₁)), a third input value I₃ is 2^{β}(E(s₃=0)−E(s₃=1)), a fourth input value I₄ may be 2^{β}(E(s₄=0)−E(s₄=1)), and each input value may be calculated based on Equations 9 and 10.

The bit updating circuits 221 to 224 may update the bits s₁ to s₄ of the candidate number based on the input values I₁ to I₄ generated in the energy calculating circuit 210. The first bit updating circuit 221 receives the first input value I₁ from the energy calculating circuit 210 and updates the first bit s₁. The second bit updating circuit 222 receives the second input value I₂ from the energy calculating circuit 210 and updates the second bit s₂. The third bit updating circuit 223 receives the third input value I₃ from the energy calculating circuit 210 and updates the third bit s₃. The fourth bit updating circuit 224 receives the fourth input value I₄ from the energy calculating circuit 210 and updates the fourth bit s₄.

The bit updating circuits 221 to 224 may simultaneously update the bits s₁ to s₄. In other words, update of the first bit s₁, update of the second bit s₂, update of the third bit s₃, and update of the fourth bit s₄ may be simultaneously performed. Accordingly, even if the number of bits of the candidate number increases as the target number increases, the candidate number may be updated at high speed. Compared with a case of updating bits sequentially, the candidate number may be updated at high speed.

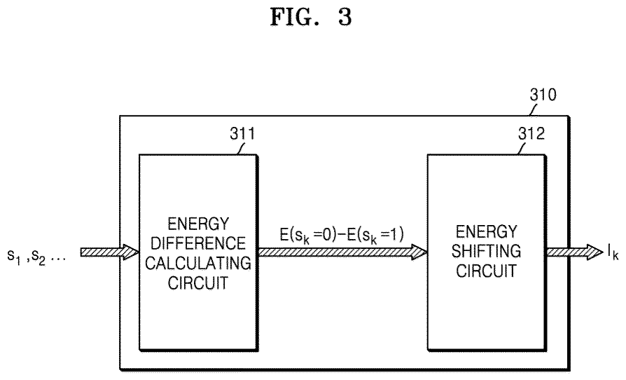

FIG. 3 is a block diagram of an energy calculating circuit 310, according to an embodiment.

According to an embodiment, the energy calculating circuit 310 includes an energy difference calculating circuit 311 and an energy shifting circuit 312. The energy difference calculating circuit 311 and the energy shifting circuit 312 may be used to generate input values for updating the candidate number. The input values may be simultaneously generated. The generation of a k^{th} input value Iₖ among the input values will be described.

The energy difference calculating circuit 311 may receive bits s₁, s₂, . . . of the candidate number from the bit updating circuits. The energy difference calculating circuit 311 may be configured to calculate a difference E(ₛₖ=0)−E(ₛₖ=1) between a value E(ₛₖ=0) of an energy function when a k^{th} bit of the candidate number is 0 and a value E(ₛₖ=1) of the energy function when the k^{th} bit of the candidate number is 1.

The energy difference calculating circuit 311 may calculate E(ₛₖ=0)−E(ₛₖ=1) based on Equations 9 and 10. The energy difference calculating circuit 311 may calculate E(ₛₖ=0)−E(ₛₖ=1) based on Equation 9 for the first candidate number A and calculate E(ₛₖ=0)−E(ₛₖ=1) based on Equation 10 for the second candidate number B.

For example, the energy difference calculating circuit 311 may calculate 2^{3+k-2n}(N−AB)B+2^{1+2k-2n}B² for the first candidate number A. The energy difference calculating circuit 311 may include a logic circuit for calculating (N−AB)B and B² and a shifting circuit for calculating multiplication of output of the logic circuit and 2^{3+k-2n} and 2^{1+2k-2n}. The energy difference calculating circuit 311 may calculate 2^{3+k-2n}(N−AB)B+2^{1+2k-2n}B² when a k^{th} bit of the first candidate number A is 1 and otherwise, calculate 2^{3+k-2n}(N−AB)B−2^{1+2k-2n}B².

The energy shifting circuit 312 may generate the k^{th} input value Iₖ by performing a shift operation on output of the energy difference calculating circuit 311. For example, the energy shifting circuit 312 may shift output E(ₛₖ=0)−E(ₛₖ=1) of the energy difference calculating circuit 311 to a shift value β ((E(ₛₖ=0)−E(ₛₖ=1))<<β).

The energy shifting circuit 312 may perform a shift operation by cycling through predetermined shift numbers and using these as shift values. For example, the predetermined shift values may be 0 to 5, and the energy shifting circuit 312 may cycle through 0 to 5 in any order and may use these as a shift value.

The energy shifting circuit 312 may perform a shift operation by cycling through predetermined shift values in order from small to large and using these as a shift value. For example, the predetermined shift values may be 0, 1, and 2, and the energy shifting circuit 312 may perform the shift operation by cycling in the order of 0, 1, and 2. For example, the energy shifting circuit 312 may generate a k^{th} input value Iₖ by performing a shift operation of (E(ₛₖ=0)−E(ₛₖ=1))<<0, generate the k^{th} input value Iₖ by performing a shift operation of (E(ₛₖ=0)−E(ₛₖ=1))<<1 in a next cycle, generate the k^{th} input value Iₖ by performing a shift operation of (E(ₛₖ=0)−E(ₛₖ=1))<<2 in a next cycle, generate the k^{th} input value Iₖ by performing a shift operation of (E(ₛₖ=0)−E(ₛₖ=1))<<0 in a next cycle, and so on.

The shift operation may be replaced by a multiplication operation. For example, a 1-bit left shift operation may be replaced by a 2× multiplication operation, and a 2-bit left shift operation may be replaced by a 4× multiplication operation. Thus, in some embodiments, the energy shifting circuit 312 may be replaced by a multiplication circuit.

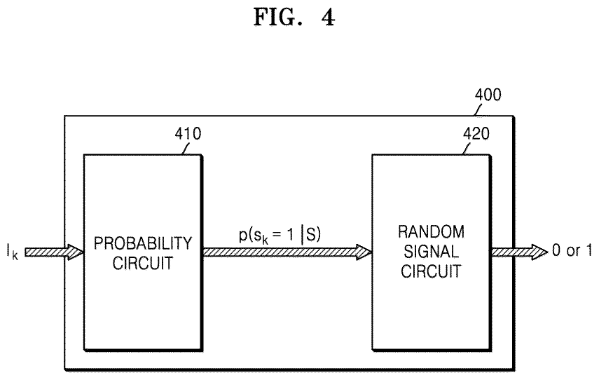

FIG. 4 is a block diagram of a k^{th} bit updating circuit 400, according to an embodiment.

An electronic device according to an embodiment may include a plurality of bit updating circuits. The plurality of bit updating circuits may be configured identically. With reference to FIG. 4, a k^{th} bit updating circuit among the plurality of bit updating circuits will be described.

In an embodiment, the k^{th} bit updating circuit 400 includes a probability circuit 410 and a random signal circuit 420.

The probability circuit 410 may output probability p(sk=1|S) that a k^{th} bit of the candidate number is 1 for a state variable S determined by bits of the candidate number. The probability circuit 410 may receive the k^{th} input value Iₖ from the energy calculating circuit and output the probability p(sₖ=1|S) based on the received k^{th} input value Iₖ.

The probability p(sk=1|S) that a k^{th} bit of the candidate number is 1 may be predetermined to increase as the k^{th} input value Iₖ increases. For example, the probability p(sₖ=1|S) may be a linear increasing function for an input value Iₖ. Alternatively, the probability p(sₖ=1|S) may be a non-linear increasing function for the input value Iₖ. The probability p(sₖ=1|S) may be a sigmoid function for the input value Iₖ. Alternatively, the probability p(sₖ=1|S) may be a softmax function for the input value Iₖ. A relationship between the probability p(sk=1|S) and the input value Iₖ is not limited by listed examples.

The probability p(sₖ=1|S) that a k^{th} bit of the candidate number is 1 may be stored in a look-up table (LUT). The probability circuit 410 may output the probability p(sk=1|S) by reading a value of the LUT corresponding to the input value Iₖ.

The random signal circuit 420 may randomly generate 0 or 1 based on the output value of the probability circuit 410. When the output value of the random signal circuit 420 is 0, a k^{th} bit of the candidate number may be updated to 0. Alternatively, when the output value of the random signal circuit 420 is 1, the k^{th} bit of the candidate number may be updated to 1.

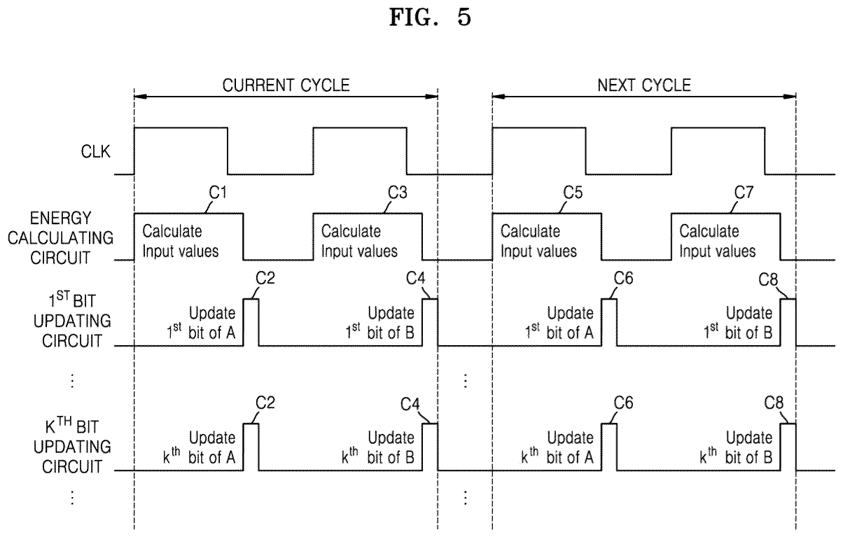

FIG. 5 is a timing diagram showing operations of an energy calculating circuit and bit updating circuits, according to an embodiment.

Operations for updating the first candidate number A and the second candidate number B may be performed over a plurality of cycles. With reference to FIG. 5, operations in a current cycle and a next cycle among a plurality of cycles will be described.

In a first sub cycle C1 of the current cycle, the energy calculating circuit may generate first input values in response to a clock signal CLK.

For example, a k^{th} first input value generated in the first sub cycle C1 may be (E(ₛₖ=0)−E(ₛₖ=1)<<β₁. β₁ may be one of predetermined shift values.

In a second sub cycle C2 of the current cycle, the bit updating circuits may update bits of the first candidate number A based on the first input values. A first bit updating circuit may update a first bit of the first candidate number A based on a 1^{st} first input value. A k^{th} bit updating circuit may update a k^{th} bit of the first candidate number A based on a k^{th} first input value. Bits of the first candidate number A may be simultaneously updated by the bit updating circuits.

In a third sub cycle C3 of the current cycle, the energy calculating circuit may generate second input values in response to the clock signal CLK.

For example, the k^{th} second input value generated in the third sub cycle C3 may be (E(ₛₖ=0)−E(ₛₖ=1)<<β₂. β₂ may be the same value as a shift value β₁ used in the first sub cycle C1.

In a fourth sub cycle C4 of the current cycle, the bit updating circuits may update bits of the second candidate number B based on the second input values. A first bit updating circuit may update a first bit of the second candidate number B based on a 1^{st} second input value. A k^{th} bit updating circuit may update a k^{th} bit of the second candidate number B based on a k^{th} second input value. Bits of the second candidate number B may be simultaneously updated by the bit updating circuits.

In a first sub cycle C5 and a second sub cycle C6 of the next cycle, the energy calculating circuit may generate first input values in response to the clock signal CLK, and the bit updating circuits may update bits of the first candidate number A based on the first input values.

For example, a k^{th} first input value generated in the first sub cycle C5 may be (E(ₛₖ=0)−E(ₛₖ=1))<<β₃. β₃ may be a different value from shift values β₁ and β₂ used in the current cycle.

In a third sub cycle C7 and a fourth sub cycle C8 of the next cycle, the energy calculating circuit may generate second input values in response to the clock signal CLK, and the bit updating circuits may update bits of the second candidate number B based on the second input values.

For example, a k^{th} second input value generated in a fourth sub cycle C8 may be (E(ₛₖ=0)−E(ₛₖ=1))<<β₄. β₄ may be the same value as the shift value β₃ used in the first sub cycle C5 of a next cycle.

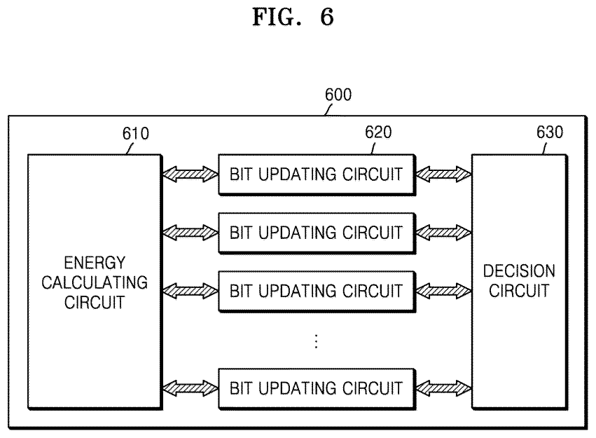

FIG. 6 shows an electronic device 600 according to an embodiment.

According to an embodiment, the electronic device 600 includes an energy calculating circuit 610, a plurality of bit updating circuits 620, and a decision circuit 630. The above descriptions may be applied to the energy calculating circuit 610 and the plurality of bit updating circuits 620, and thus redundant descriptions are omitted, and the decision circuit 630 will be described.

The decision circuit 630 is configured to determine whether factorization of the target number is complete. In an embodiment, the decision circuit 630 may determine whether factorization of the target number is complete by performing a modulo operation on the target number and the candidate number.

The decision circuit 630 may determine whether factorization of the target number is complete by performing the modulo operation on the target number and a first candidate number. The decision circuit 630 may determine whether factorization of the target number is complete by performing the modulo operation on the target number and a second candidate number.

When any one of the first and second candidate numbers reaches a solution by using the modulo operation, whether factorization of the target number is complete may be immediately determined.

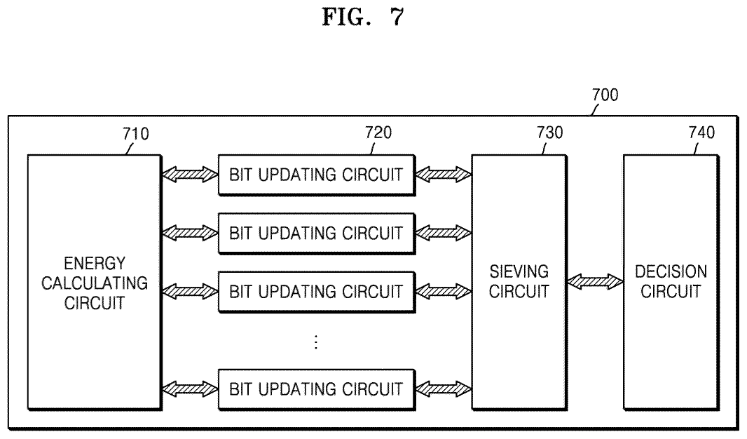

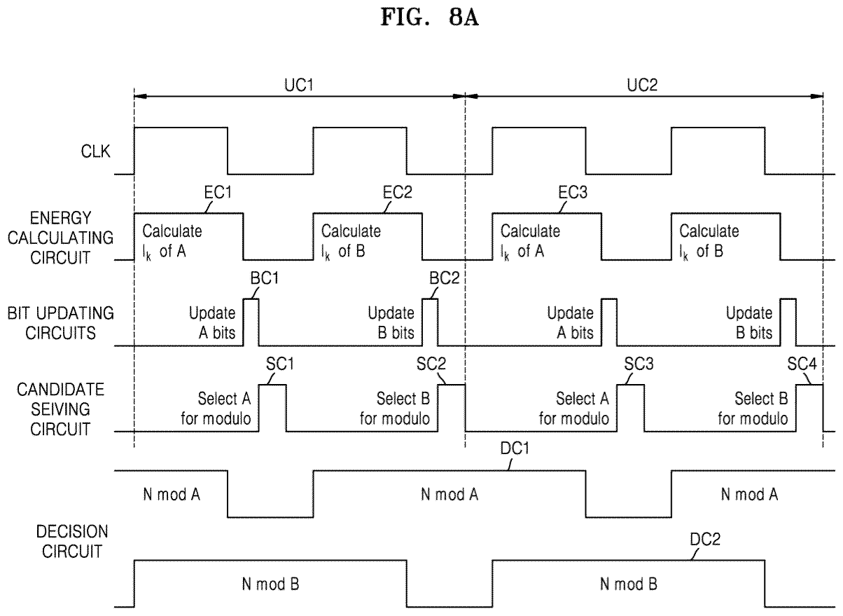

FIG. 7 shows an electronic device 700 according to an embodiment.

In an embodiment, the electronic device 700 includes an energy calculating circuit 710, a plurality of bit updating circuits 720, a sieving circuit 730, and a decision circuit 740. The above descriptions may be applied to the energy calculating circuit 710 and the plurality of bit updating circuits 720, and thus redundant descriptions are omitted, and the sieving circuit 730 and the decision circuit 740 will be described.

The sieving circuit 730 is configured to determine a final candidate number among the candidate number and odd numbers adjacent to the candidate number. In an embodiment, the sieving circuit 730 is configured to determine a number that is not a multiple of 3, a multiple of 5, and a multiple of 7 as a final candidate number among the candidate number and odd numbers adjacent to the candidate number.

For example, for the first candidate number A, the sieving circuit 730 may determine a final candidate number among A−4, A−2, A, A+2, and A+4. The sieving circuit 730 may determine whether A−4, A−2, A, A+2, and A+4 are multiples of 3, 5, or 7, and determine a number that is not multiples of 3, 5, and 7 as the final candidate number.

For example, for the first candidate number A, the sieving circuit 730 may determine the final candidate number among A−2, A, A+2, and A+4. The sieving circuit 730 may determine whether A−2, A, A+2, and A+4 are multiples of 3, 5, or 7, and determine a number that is not multiples of 3, 5, and 7 as the final candidate number. When A−2, A, A+2, and A+4 are all multiples of 3, 5, or 7, the sieving circuit 730 may determine A−4 as the final candidate number.

The decision circuit 740 is configured to determine whether factorization of the target number is complete. In an embodiment, the decision circuit 740 may determine whether factorization of the target number is complete by performing the modulo operation on the target number and the final candidate number.

Multiples of 3, 5, and 7 may be quickly identified. The sieving circuit 730 may determine a number that is not a multiple of 3, a multiple of 5, and a multiple of 7 among the candidate number and odd numbers adjacent to the candidate number as the final candidate number, and thus a solution of prime factorization of a semiprime may be reached more quickly.

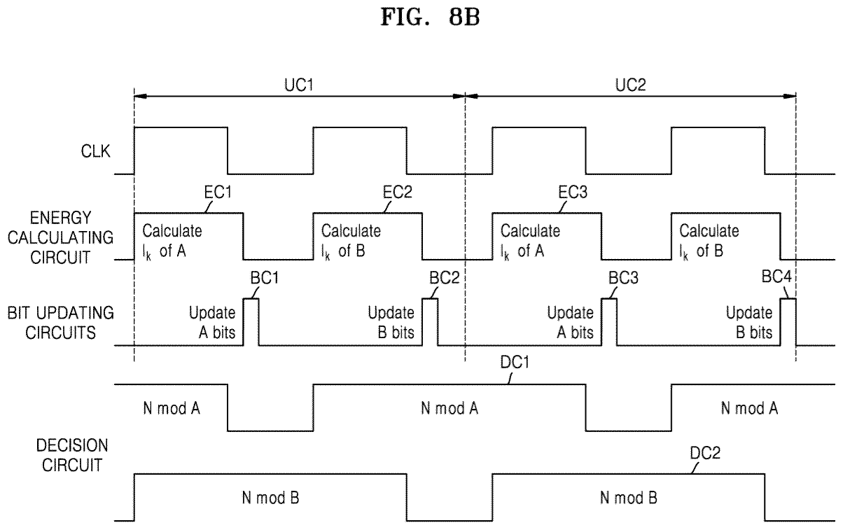

FIG. 8A is a timing diagram showing operations of an energy calculating circuit, bit updating circuits, a sieving circuit, and a decision circuit, according to an embodiment.

First and second candidate numbers may be searched to satisfy a solution of factorization of the target number through repeated candidate update cycles and decision cycles.

In an embodiment, a candidate update cycle UC1 may include first and second energy calculating cycles EC1 and EC2, first and second bit updating cycles BC1 and BC2, and first and second sieving cycles SC1 and SC2.

In the first and second energy calculating cycles EC1 and EC2, input values for updating the candidate number may be generated by the energy calculating circuit. In the first and second bit updating cycles BC1 and BC2, candidate numbers may be updated by the bit updating circuits. In the first and second sieving cycles SC1 and SC2, the final candidate numbers may be determined by the sieving circuit.

In the first and second energy calculating cycles EC1 and EC2, predetermined shift values may be used to generate input values.

Predetermined shift values may be used by cycling every candidate update cycle. For example, when predetermined shift values are β₁ and β₂, β₁ may be used as a shift value in the current candidate update cycle UC1, β₂ may be used as a shift value in a next candidate update cycle UC2, and β₁ may be used as a shift value in a next candidate update cycle.

Predetermined shift values may be used by cycling in order from small to large every candidate update cycle. For example, when predetermined shift values are 0, 1, and 2, in the current candidate update cycle UC1, 0 may be used as a shift value, in the next candidate update cycle UC2, 1 may be use as a shift value, and in a next candidate update cycle, 2 may be used as a shift value.

In a first energy calculating cycle EC1, the energy calculating circuit may generate first input values in response to the clock signal CLK and transfer the first input values to the bit updating circuits.

For example, the k^{th} first input value may be (E(ₛₖ=0)−E(ₛₖ=1))<<β₁. The k^{th} first input value may be calculated based on Equation 9. In an operation of Equation 9, the first candidate number before being updated in the first bit updating cycle BC1 and the second candidate number before being updated in the second bit updating cycle BC2 may be used.

In response to completion of the first energy calculating cycle EC1, the first bit updating cycle BC1 may be started. In the first bit updating cycle BC1, the bit updating circuits may update bits of the first candidate number based on the first input values. In the first bit updating cycle BC1, bits of the first candidate number may be simultaneously updated.

In response to completion of the first bit updating cycle BC1, the first sieving cycle SC1 may be started. In the first sieving cycle SC1, the sieving circuit may determine a first final candidate number among the first candidate number and odd numbers adjacent to the first candidate number.

In the second energy calculating cycle EC2, the energy calculating circuit may generate second input values in response to the clock signal CLK and transfer the second input values to the bit updating circuits.

For example, the k^{th} second input value may be (E(ₛₖ=0)−E(ₛₖ=1))<<β₁. The k^{th} second input value may be calculated based on Equation 10. In an operation of Equation 10, the first final candidate number and the second candidate number before being updated in the second bit updating cycle BC2 may be used.

In response to completion of the second energy calculating cycle EC2, the second bit updating cycle BC2 may be started. In the second bit updating cycle BC2, the bit updating circuits may update bits of the second candidate number based on the second input values. In the second bit updating cycle BC2, bits of the second candidate number may be simultaneously updated.

In response to completion of the second bit updating cycle BC2, the second sieving cycle SC2 may be started. In the second sieving cycle SC2, the sieving circuit may determine a second final candidate number among the second candidate number and odd numbers adjacent to the second candidate number.

The first and second final candidate numbers determined in the current update cycle UC1 may be used to generate the first input values in a first energy calculating cycle EC3 of the next update cycle UC2.

In first and second decision cycles DC1 and DC2, whether factorization of the target number is complete may be determined by the decision circuit.

In the first decision cycle DC1, the decision circuit may determine whether factorization of the target number is complete based on the first final candidate number. The decision circuit may perform a modulo operation of the target number and the first final candidate number, and when a remainder is 0, the decision circuit may determine that factorization is complete.

In the second decision cycle DC2, the decision circuit may determine whether factorization of the target number is complete based on the second final candidate number. The decision circuit may perform the modulo operation of the target number and the second final candidate number, and when a remainder is 0, the decision circuit may determine that factorization is complete.

The first decision cycle DC1 may be performed between the first sieving cycle SC1 of the current update cycle UC1 and a first sieving cycle SC3 of the next update cycle UC2. The second decision cycle DC2 may be performed between the second sieving cycle SC2 of the current update cycle UC1 and a second sieving cycle SC4 of the next update cycle UC2. As such, whether the first final candidate number is a solution may be determined while the second candidate number is updated, and whether the second final candidate number is a solution may be determined while the first candidate number is updated, and thus operations for factorization of the target number may be performed time-efficiently.

FIG. 8B is a timing diagram showing operations of an energy calculating circuit, bit updating circuits, and a decision circuit, according to an embodiment.

The timing diagram of FIG. 8B is different from the timing diagram of FIG. 8A in that the timing diagram of FIG. 8B does not include a sieving cycle. For convenience of explanation, redundant descriptions of the timing diagram of FIG. 8A are omitted.

The first and second candidate numbers updated in the current update cycle UC1 may be used to generate the first input values in the first energy calculating cycle EC3 of the next update cycle UC2.

In the first and second decision cycles DC1 and DC2, whether factorization of the target number is complete may be determined by the decision circuit.

In the first decision cycle DC1, the decision circuit may determine whether factorization of the target number is complete based on the first candidate number updated in the first bit updating cycle BC1. The decision circuit may perform a modulo operation of the target number and the first candidate number, and when a remainder is 0, the decision circuit may determine that factorization is complete.

In the second decision cycle DC2, the decision circuit may determine whether factorization of the target number is complete based on the second candidate number updated in the second bit updating cycle BC2. The decision circuit may perform the modulo operation of the target number and the second candidate number, and when a remainder is 0, the decision circuit may determine that factorization is complete.

The first decision cycle DC1 may be executed between the first bit updating cycle BC1 of the current candidate update cycle UC1 and a first bit updating cycle BC3 of the next candidate update cycle UC2. The second decision cycle DC2 may be executed between the second bit updating cycle BC2 of the current candidate update cycle UC1 and a second bit updating cycle BC4 of the next candidate update cycle UC2. As such, whether the first candidate number is a solution may be determined while the second candidate number is updated, and whether the second candidate number is a solution may be determined while the first candidate number is updated, and thus operations for factorization of the target number may be performed time-efficiently.

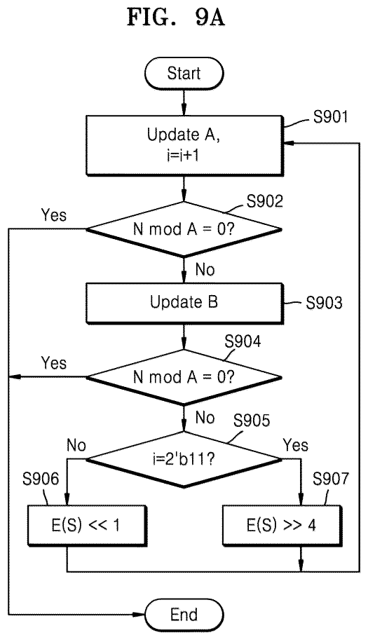

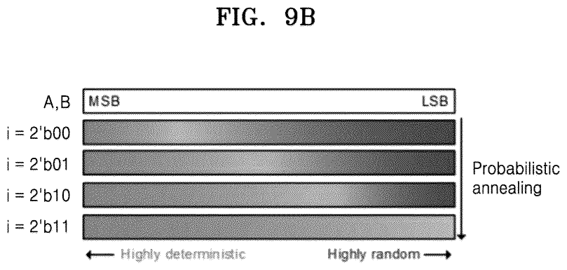

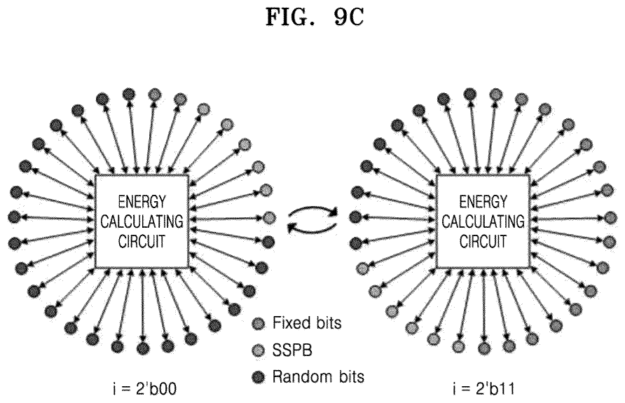

FIGS. 9A to 9C are diagrams for explaining a probabilistic annealing method, according to an embodiment.

A method of minimizing the energy function E(S) by an electronic device according to embodiments will be referred to as a probabilistic annealing method.

Dominant factors in the energy function E(S) represented according to Equation 3 may be most significant bits (MSBs) of the candidate numbers A and B. Accordingly, when the candidate numbers A and B are updated to the input values generated based on the energy function E(S), MSBs of the candidate numbers A and B and bits close to the MSBs may be updated to minimize the energy function E(S) in a probabilistic area.

When the energy function E(S) is shifted left, the MSBs of the candidate numbers A and B and bits close to the MSBs may be moved to a deterministic area, and least significant bits (LSBs) of the candidate numbers A and B and bits close to the LSBs may be moved to a probabilistic area. Accordingly, p bits updated in the probabilistic area may be moved from the MSB toward the LSB. Here, the p bits are bits that have a major influence on optimization of the energy function E(S), and are referred to as system-significant p-bits (SSPB).

In the probabilistic annealing method, the candidate numbers A and B are updated using input values generated based on the shifted energy function E(S) to update all bits of the candidate numbers A and B in the probabilistic area. As the energy function E(S) is shifted by cycling through predetermined shift values in order from small to large and using these as shift values, a SSPB in the probabilistic area may be moved from the MSB to a less significant bit.

FIG. 9A is a flowchart of optimization of an energy function E(S) based on a probabilistic annealing method, according to an embodiment. In an embodiment, a shift operation is performed on the energy function E(S) using predetermined shift values 0 to 3, and candidate numbers A and B that satisfy a solution are searched.

In operation S901, the first candidate number A is updated to input values generated based on the energy function E(S).

In operation S902, whether a result of a modulo operation of a target number N and a first candidate number A is 0 may be determined. When the result of the modulo operation is 0, the first candidate number A is a solution, and thus the search is terminated. When the result of the modulo operation is not 0, operation S903 proceeds.

In operation S903, the candidate number B is updated to input values generated based on the energy function E(S).

In operation S904, whether the result of the modulo operation of the target number N and the second candidate number B is 0 may be determined. When the result of the modulo operation is 0, the second candidate number B is a solution, and thus the search is terminated. When the result of the modulo operation is not 0, operation S905 proceeds.

In operation S905, whether cycling of predetermined values is complete may be determined. Whether cycling of predetermined shift values is complete may be determined from whether the number of times cycling from start to end of FIG. 9 is repeated is equal to the number of predetermined shift values.

When cycling of predetermined shift values is not complete, operation S906 proceeds, and a 1-bit left shift operation is performed on the energy function E(S). Accordingly, the energy function E(S) may be left shifted by 1 bit, 2 bits, or 3 bits.

When cycling of predetermined shift values is complete, operation S907 proceeds, and a 4-bit right shift operation is performed on the energy function E(S). Accordingly, the energy function E(S) may return to an unshifted state.

Referring to FIG. 9B, as the energy function E(S) is shifted left, MSBs of the candidate numbers A and B and bits close to the MSBs may be moved to a deterministic area, and LSBs of the candidate numbers A and B and bits close to the LSBs may be moved to a probabilistic area. Referring to FIG. 9C, as the energy function E(S) is shifted left, a SSPB may be moved from the MSB to the LSB.

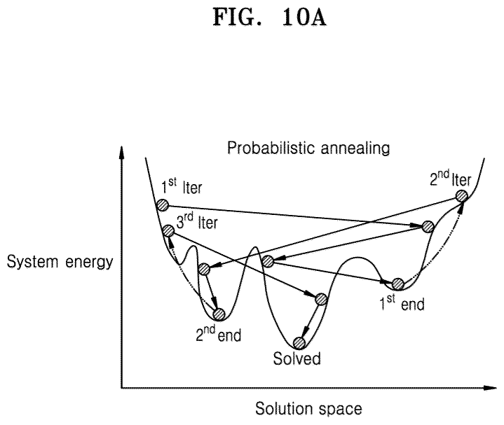

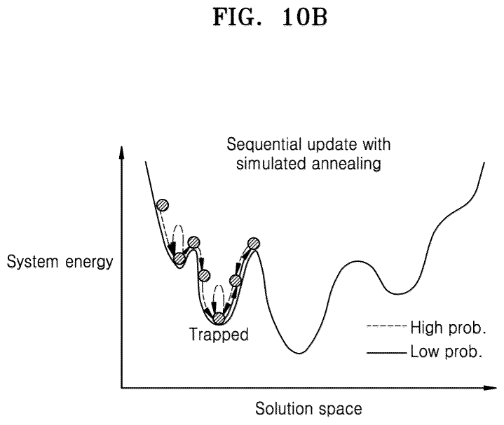

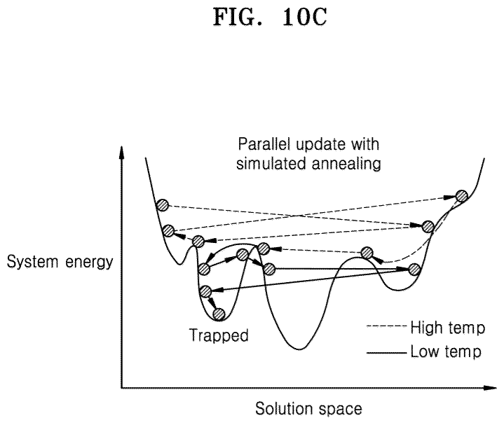

FIGS. 10A to 10C are graphs for explaining a difference between a probabilistic annealing method and methods according to the related art.

In sequential update of FIG. 10B as the method according to the related art, a system is updated such that each bit of a candidate number has as low energy as possible. Accordingly, as update proceeds, it becomes difficult to overcome an energy barrier, and thus the system may be trapped in a local minimum.

Parallel update of FIG. 10C as the method according to the related art is designed to gradually reduce temperature. The parallel update has a disadvantage that a system converges slowly and is trapped in a local minimum in a final stage.

In the probabilistic annealing method of FIG. 10A according to embodiments, bits of the candidate number may be simultaneously updated, and thus the system may be converged quickly by passing an energy barrier. Divergence of the system may be prevented by shifting the energy function and searching for a candidate number. A solution may be accurately determined through a modulo operation, and thus the system may deviate from a local minimum and converge to a global minimum.

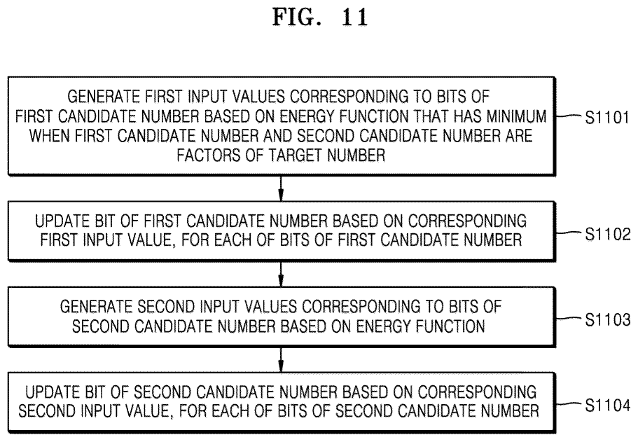

FIG. 11 is a flowchart of a method for factorization of a target number according to an embodiment.

In operation S1101, first input values corresponding to bits of the first candidate number may be generated based on an energy function that has a minimum when a first candidate number and a second candidate number are a solution of factorization of a target number.

The energy calculating circuit may generate first input values corresponding to the bits of the first candidate number based on Equation 9.

In operation S1102, for each of the bits of the first candidate number, a bit of the first candidate number may be updated based on a corresponding first input value.

Each of the bit updating circuits may update the bit of the first candidate number based on a corresponding first input value. The bits of the first candidate number may be simultaneously updated by the bit updating circuits.

In operation S1103, based on the energy function, second input values corresponding to bits of a second candidate number may be generated.

The energy calculating circuit may generate the second input values corresponding to the bits of the second candidate number based on Equation 10.

In operation S1104, for each of the bits of the second candidate number, a bit of the second candidate number may be updated based on a corresponding second input value.

Each of the bit updating circuits may update the bit of the second candidate number based on the corresponding second input value. The bits of the second candidate number may be simultaneously updated by the bit updating circuits.

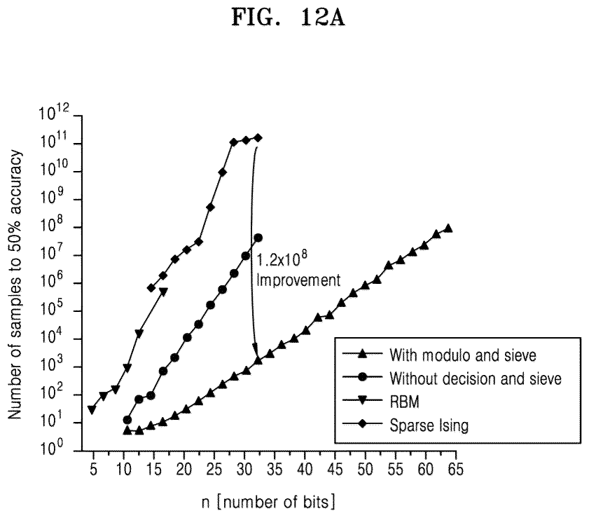

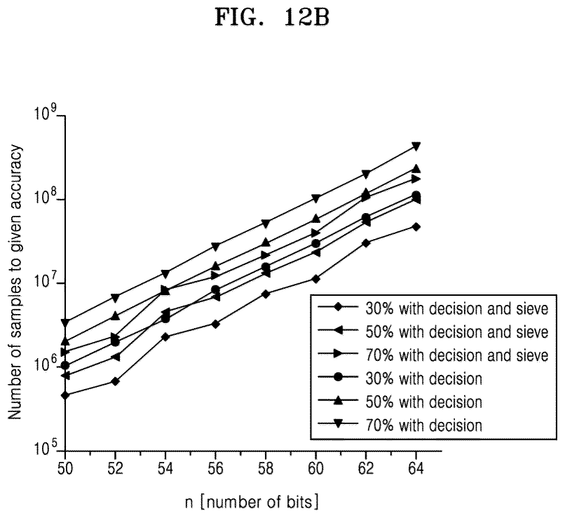

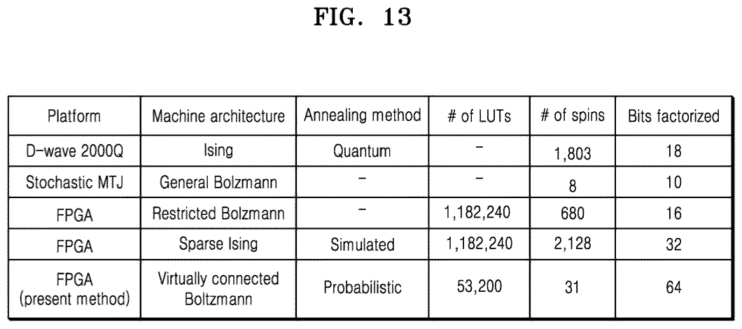

FIGS. 12A to 13 are diagrams for explaining an effect of a method proposed according to embodiments.

A graph of FIG. 12A shows the number of samples (i.e., candidate numbers) needed to achieve accuracy of 50% for the number of bits of the target number. Here, the number of samples needed to achieve accuracy of 50% refers to the number of samples associated with the median trial among N trials of the factorization which are arranged in ascending order of the time required to find the correct solution. A first plot -▴- represents results of factorization using an electronic device including a decision circuit and a sieving block according to embodiments, a second plot -●- represents results of factorization using an electronic device that does not include a decision circuit and a sieving circuit according to embodiments, and third and fourth plots -▾- and -♦- represent results of factorization in first and second methods according to the related art, respectively. In factorization using the electronic device that does not include a decision circuit and a sieving circuit, factorization based on a value of an energy function is determined to be complete.

The first method according to the related art takes a long time for factorization, and thus it is difficult to perform factorization for a target number exceeding 16 bits. The second method according to the related art also takes a long time for factorization, and thus it is difficult to perform factorization for a target number exceeding 32 bits. In contrast, in the methods proposed according to embodiments, factorization of a large target number is complete in a shorter time than the methods according to the related art. In particular, in factorization using the electronic device including the decision circuit and the sieving circuit, factorization of a target number of 64 bits is complete.

In comparison for a target number of 32 bits, there is a difference in the number of samples of 1.2×10⁸ times between the first plot -▴- and the fourth plot -♦-, and there is a difference in the number of samples of 1.4×10⁴ times between the second graph -●- and the fourth plot -♦-. As seen from this, the methods proposed according to embodiments may require a much smaller number of samples to achieve the target performance of factorization than the methods according to the related art.

A graph of FIG. 12B shows the number of samples (i.e., candidate numbers) needed to achieve accuracy of 30%, 50%, and 70% for the number of bits of the target number. First, second, and third plots -♦-, [symbol] , and [symbol] represent results of factorization using an electronic device including a decision circuit and a sieving circuit according to embodiments, respectively, and fourth, fifth, and sixth plots -●-, -▴-, and -▾- represent results of factorization using an electronic device that does not include a decision circuit according to embodiments, respectively. In factorization using the electronic device that does not include a decision circuit, factorization based on a value of an energy function is determined to be complete.

Referring to the plots in FIG. 12B, the number of samples is reduced by up to 66% at accuracy of 50% due to a sieving circuit. As seen from this, a speed of factorization is improved through an operation of sieving candidate numbers according to embodiments.

A table of FIG. 13 shows hardware resources and the number of bits of a target number of each method Second to fifth rows of the table in FIG. 13 represent methods according to the related art and a sixth row represents the method proposed according to embodiments.

Referring to the table of FIG. 13, it may be possible to factorize a target number of 64 bits by using the method proposed according to the disclosure. This is a level that is difficult to achieve using the methods according to the related art. It may be possible to factorize a target number of 64 bits with 53,200 LUTs and 31 spins (i.e., bits) using the method proposed according to the disclosure. As seen from this, it may be possible to perform factorization of a much larger target number with a much smaller number of hardware resources using the method proposed by the disclosure than the methods according to the related art.

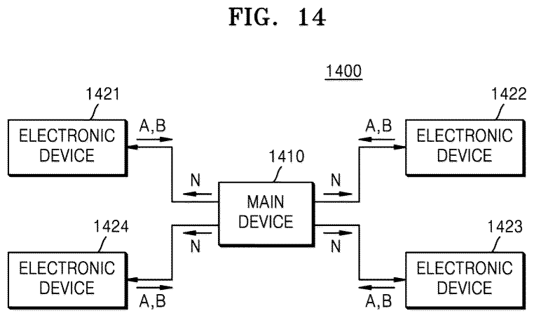

FIG. 14 is a block diagram of an electronic system 1400 according to an embodiment.

In an embodiment, the electronic system 1400 includes a main device 1410 and electronic devices 1421 to 1424. For convenience of description, the four electronic devices 1421 to 1424 are used, and the number of the electronic devices 1421 to 1424 is not limited thereto.

The main device 1410 may be configured to control the overall operation of the electronic system 1400. The main device 1410 may include a processor and a memory for an operation of the electronic system 1400.

The above description of the electronic device according to embodiments may be applied to the electronic devices 1421 to 1424. For convenience of description, redundant descriptions are omitted.

In the electronic system 1400, factorization of the target number N may be performed by the electronic devices 1421 to 1424. The electronic devices 1421 to 1424 may simultaneously start factorization of the target number N, and thus factorization of the target number N may be performed in time parallel by the electronic devices 1421 to 1424. When any one of the electronic devices 1421 to 1424 completes factorization, factorization of the remaining electronic devices may be stopped, and factorization of the electronic system 1400 may be terminated.

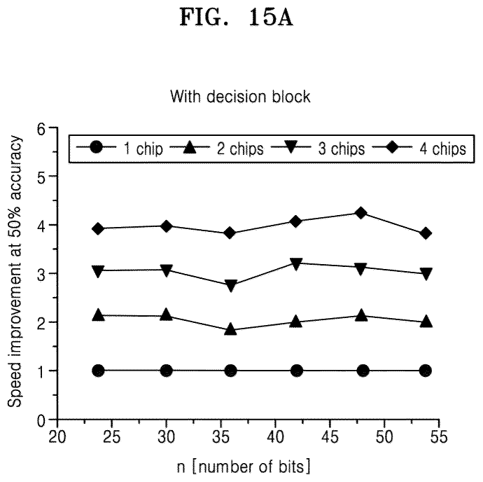

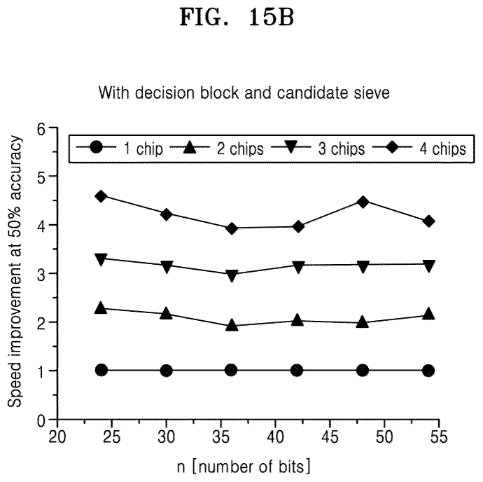

FIGS. 15A and 15B are graphs for explaining an effect of an electronic system according to embodiments.

A graph of FIG. 15A shows the number of samples (i.e., candidate numbers) needed to achieve accuracy of 50% for the number of bits of the target number. First to fourth plots -●-, -▴-, -▾-, and -♦- represent results of factorization using an electronic system having one to four electronic devices, respectively. Each electronic device of the electronic system includes a decision circuit.

Referring to the graph of FIG. 15A, compared with the electronic system including one electronic device, the number of samples for the electronic systems including 2 to 4 electronic devices decreases by 2.01, 3.05, and 3.98 times, respectively.

A graph of FIG. 15B shows the number of samples (i.e., candidate numbers) needed to achieve accuracy of 50% for the number of bits of the target number. First to fourth plots -●-, -▴-, -▾-, and -♦- represent results of factorization using an electronic system having one to four electronic devices, respectively. Each electronic device of the electronic system includes a decision circuit and a sieving circuit.

Referring to the graph of FIG. 15B, compared with the electronic system with one electronic device, the number of samples for the electronic systems with 2 to 4 electronic devices decreases by 2.07, 3.17, and 4.22 times, respectively.

The electronic device according to embodiments represents a fully-connected Boltzmann machine, and thus, as seen from FIGS. 15A and 15B, the performance of the electronic system may be improved in proportion to the number of electronic devices.

The method for factorization of the target number described above may be recorded on a computer-readable recording medium on which one or more programs including instructions for executing the method are recorded. Examples of computer-readable recording media include magnetic media such as hard disks, floppy disks and magnetic tapes, optical media such as CD-ROMs and DVDs, magneto-optical media such as floptical disks, and hardware devices specifically configured to store and perform program instructions such as ROM, a RAM, and a flash memory. Examples of the program commands include a machine language code created by a compiler and a high-level language code executable by a computer using an interpreter and the like.

The electronic device for factorization of a target number according to the technical idea of the disclosure may not require weights.

The electronic device may not require a circuit for a multiply-accumulate (MAC) operation of a weight-spin.

The electronic device may be reconfigurable for any target number.

It may be possible to factorize a target number with any size by changing the number of bit updating circuits.

Compared to the related art, it may be possible to factorize a large target number with fewer hardware resources.

It will be appreciated by persons skilled in the art that the effects that could be achieved with embodiments are not limited to what has been particularly described hereinabove and other advantages of the disclosure will be more clearly described and understood from the above detailed description. That is, unintended effects resulting from implementing embodiments may also be derived by those skilled in the art from the embodiments.

The foregoing description of the disclosure is for illustrative purposes, and those skilled in the art will understand that the disclosure is to be easily modified into other specific forms without changing the technical spirit or essential features of the disclosure. Therefore, the embodiments described above needs to be understood in all respects as illustrative and not restrictive. For example, each component described as a single type may be implemented in a distributed manner, and similarly, components described as distributed may also be implemented in a combined form.

The scope of the disclosure is indicated by the claims described below rather than the detailed description above, and all changes or modified forms derived from the meaning and scope of the claims and their equivalent concepts need to be construed as being included in the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An electronic device for factorization of a target number, the electronic device comprising:
an energy calculating circuit configured to generate input values for updating bits of a candidate number based on an energy function that has a minimum when the candidate number is a factor of the target number; and
bit updating circuits corresponding to the bits of the candidate number, respectively,
wherein the energy calculating circuit is further configured to receive bit values of the candidate number from the bit updating circuits and generate the input values based on the bit values of the candidate number, and
wherein a k^{th} bit updating circuit of the bit updating circuits is configured to receive a k^{th} input value for a k^{th} bit of the candidate number from the energy calculating circuit, from among the input values, and update the k^{th} bit of the candidate number based on the k^{th} input value.

2. The electronic device of claim 1, wherein the candidate number includes a first candidate number and a second candidate number, and
wherein the bit updating circuits are configured to:
update the first candidate number in a cycle for updating the first candidate number; and
update the second candidate number in a cycle for updating the second candidate number.

3. The electronic device of claim 1, wherein the bit updating circuits further are configured to simultaneously update each bit of the candidate number.

4. The electronic device of claim 1, further comprising a decision circuit configured to determine whether factorization of the target number is complete based on the candidate number.

5. The electronic device of claim 4, wherein the decision circuit is further configured to determine whether factorization of the target number is complete by performing a modulo operation on the target number and the candidate number.

6. The electronic device of claim 4, further comprising a sieving circuit configured to determine a final candidate number among the candidate number and odd numbers adjacent to the candidate number.

7. The electronic device of claim 6, wherein the sieving circuit is further configured to determine, as the final candidate number, a number that is not a multiple of 3, a multiple of 5, and a multiple of 7 among the candidate number and the odd numbers adjacent to the candidate number.

8. The electronic device of claim 6, wherein the decision circuit is further configured to determine whether factorization of the target number is complete by performing a modulo operation on the target number and the final candidate number.

9. The electronic device of claim 1, wherein the energy calculating circuit includes an energy difference calculating circuit configured to calculate a difference between a value of the energy function when the k^{th} bit of the candidate number is 0 and a value of the energy function when the k^{th} bit of the candidate number is 1.

10. The electronic device of claim 9, wherein the energy calculating circuit further includes an energy shifting circuit configured to generate the k^{th} input value by performing a shift operation on output of the energy difference calculating circuit.

11. The electronic device of claim 10, wherein the energy shifting circuit is further configured to perform the shift operation by cycling through predetermined shift values and using the shift values as a shift value.

12. The electronic device of claim 10, wherein the energy shifting circuit is further configured to perform the shift operation by cycling through predetermined shift values in an order from a small value to a large value and using the shift values as a shift value.

13. The electronic device of claim 1, wherein the k^{th} bit updating circuit of the bit updating circuits is configured to update the k^{th} bit of the candidate number to 0 or 1 based on a probability value corresponding to the k^{th} input value.

14. The electronic device of claim 1, wherein the candidate number includes a first candidate number and a second candidate number,
wherein, in a current cycle for updating the first candidate number and the second candidate number,
the energy calculating circuit is further configured to perform a first sub cycle of generating a first input value based on the first candidate number and the second candidate number,
the bit updating circuit is further configured to perform a second sub cycle of updating the first candidate number based on the first input value,
the energy calculating circuit is further configured to perform a third sub cycle of generating a second input value based on the first candidate number, which is updated in the second sub cycle, and the second candidate number, and
the bit updating circuit is further configured to perform a fourth sub cycle of updating the second candidate number based on the second input value.

15. The electronic device of claim 14, further comprising a decision circuit configured to determine whether factorization of the target number is complete based on the first candidate number and the second candidate number,
wherein the decision circuit is further configured to:
determine whether factorization of the target number is complete based on the first candidate number, which is updated in a second sub cycle of the current cycle, between the second sub cycle of the current cycle and a second sub cycle of a next cycle; and
determine whether factorization of the target number is complete based on the second candidate number, which is updated in the fourth sub cycle of the current cycle, between the fourth sub cycle of the current cycle and a fourth sub cycle of the next cycle.

16. A method for factorization of a target number, the method comprising a plurality of candidate update cycles for updating a first candidate number and a second candidate number,
wherein a current candidate update cycle of the plurality of candidate update cycles includes:
a first energy calculating cycle of generating first input values corresponding to bits of the first candidate number based on an energy function that has a minimum when the first candidate number and the second candidate number are factors of the target number;
a first bit updating cycle of updating a bit of the first candidate number based on a corresponding first input value, for each of the bits of the first candidate number;
a second energy calculating cycle of generating second input values corresponding to bits of the second candidate number based on the energy function; and
a second bit updating cycle of updating a bit of the second candidate number based on a corresponding second input value, for each of the bits of the second candidate number.

17. The method of claim 16, wherein the first energy calculating cycle includes:
calculating a difference between a value of the energy function when a k^{th} bit of the first candidate number is 0 and a value of the energy function when the k^{th} bit of the first candidate number is 1; and
generating a k^{th} first input value corresponding to the k^{th} bit of the first candidate number by performing a shift operation on the calculated difference for the first candidate number.

18. The method of claim 17, wherein the second energy calculating cycle includes:
calculating a difference between a value of the energy function when a k^{th} bit of the second candidate number is 0 and a value of the energy function when the k^{th} bit of the second candidate number is 1; and
generating a k^{th} second input value corresponding to the k^{th} bit of the second candidate number by performing a shift operation on the calculated difference for the second candidate number.

19. The method of claim 18, wherein the generating of the k^{th} first input value includes performing the shift operation by alternately cycling through predetermined shift values and using the shift values every candidate update cycle among the plurality of candidate update cycles, and
wherein the generating of the k^{th} second input value includes performing the shift operation using the shift values that are equal to a value in the generating of the k^{th} first input value.

20. The method of claim 16, wherein the first bit updating cycle includes updating the bit of the first candidate number to 0 or 1 based on a probability value corresponding to the corresponding first input value for each of the bits of the first candidate number.

21. The method of claim 16, wherein the second bit updating cycle includes updating the bit of the second candidate number to 0 or 1 based on a probability value corresponding to the corresponding second input value for each of the bits of the second candidate number.

22. The method of claim 16, wherein the current candidate update cycle includes:
a first sieving cycle of determining a first final candidate number among the first candidate number updated in the first bit updating cycle and odd numbers adjacent to the updated first candidate number, the first sieving cycle being between the first bit updating cycle and the second energy calculating cycle; and
a second sieving cycle of determining a second final candidate number among the second candidate number updated in the second bit updating cycle and odd numbers adjacent to the updated second candidate number, the second sieving cycle being after the second bit updating cycle.

23. The method of claim 22, further comprising:
a first decision cycle of determining whether factorization of the target number is complete based on the first final candidate number, the first decision cycle being between the first sieving cycle of the current candidate update cycle and a first sieving cycle of a next candidate update cycle; and
a second decision cycle of determining whether factorization of the target number is complete based on the second final candidate number, the second decision cycle being between the second sieving cycle of the current candidate update cycle and a second sieving cycle of the next candidate update cycle.

24. A computer-readable recording medium having recorded thereon a program for executing the method of claim 16.
